(19) United States
(12) Patent Application Publication
(10) Pub. No.: US 2026/0002290 A1
(43) Pub. Date: Jan. 1, 2026

(54) SPANDEX FIBERS WITH IMPROVED LOW-TEMPERATURE HEAT SETTABILITY

(71) Applicant: THE LYCRA COMPANY LLC, Wilmington, DE (US)

(72) Inventors: John T CASEY, Waynesboro, VA (US); Hong LIU, Waynesboro, VA (US); Robert O WALDBAUER, Waynesboro, VA (US); Andreas Juergen BLAB, Kennett Square, PA (US)

(21) Appl. No.: 18/865,614

(22) PCT Filed: May 15, 2023
(86) PCT No.: PCT/US2023/067023

§ 371 Date: Nov. 13, 2024

Related U.S. Application Data
(60) Provisional application No. 63/341,607, filed on May 13, 2022.

(51) Int. Cl. D01F 6/78; C08G 71/04; D04B 1/16; D04B 1/18

(52) U.S. Cl. CPC D01F 6/78; C08G 71/04; D04B 1/16; D04B 1/18; D10B 2331/10; D10B 2331/12; D10B 2401/063

(57) ABSTRACT

Polyurethaneurea compositions and spandex fiber, fabric and other articles of manufacture thereof with a high low-temperature heat set efficiency and effective methods for their production using mixtures of diamine chain extenders are provided.

### FIELD

This disclosure relates to spandex fibers and fabric and other articles of manufacture thereof with low-temperature heat settability and effective methods for their production using mixtures of diamine chain extenders.

### BACKGROUND

Polymers used in making spandex are usually made by forming a prepolymer between a polymeric diol and a diisocyanate, and then reacting the resulting prepolymer with a diamine in a solvent. This prepolymer is sometimes referred to as a “capped glycol.” The resulting polymer chains may then be extended by further reaction with one or more chain extenders. The chains may subsequently be terminated by the addition of a chain terminator. This chain terminator can be mixed with the chain extender or can be added separately, after the chain extender.

Spandex is typically prepared by reaction spinning, melt-spinning, dry-spinning, or wet-spinning a polyurethane solution. Dry-spinning is the process of forcing a polymer solution through spinneret orifices into a duct to form a filament. Heated gas is passed through the duct, evaporating the solvent from the filament as the filament passes through the duct. The resulting spandex can then be wound on a cylindrical core to form a spandex supply package.

Because of its good elasticity and tensile strength, spandex has been used to make articles of clothing, disposable personal care products, upholstery and other commercial and industrial products. Spandex may be blended with other natural and/or man-made fibers and/or yarns.

Spandex and spandex-containing fabrics and garments are typically heat-set to provide the fiber or fabric with good dimensional stability and to shape the finished garment. Heat setting, however, has disadvantages. Heat setting is an extra cost to finish knit elastic fabrics that contain spandex. Moreover, typical spandex heat-setting temperatures can adversely affect sensitive companion yarns. e.g., wool, cotton, polypropylene and silk thereby requiring more costly processing. Also, heat-sensitive yarns, such as those from polyacryonitrile, wool and acetate, cannot be used in spandex heat-setting steps, because the high heat-setting temperatures will adversely affect such heat-sensitive yarns.

Spandex having low heat set efficiency requires long times and high temperatures for heat setting. Fabrics containing cotton, wool, polypropylene and silk are desirably heat set at lower temperatures than fabrics based on synthetics such as nylon or polyester. It is often desirable to heat set fabrics containing both cotton and spandex, but if the spandex only has adequate heat-set efficiency at temperatures used for nylon-containing fabrics, the fabric cannot be properly and efficiently heat-set.

To reduce the energy consumption for sustainability in textile processes and to maintain the fabric quality with heat-sensitive hard yarns, it is desirable for fabrics with spandex fibers to be heat-set at lower temperatures while still maintaining quality appearance and aesthetics.

A variety of methods have been used to improve the heat-set efficiency of spandex and thereby lower the temperature at which the spandex can be heat-set.

For example, U.S. Pat. No. 5,948,875 discloses spandex fibers based on polyurethaneureas using 2-methyl-pentamethylenediamine (MPMD) as one component of the diamine chain extenders with at least 50 mole % for increased heat-set efficiency at reduced temperatures.

CN 103255500 B discloses a method of manufacturing low-temperature heat settable polyurethane elastic fibers with a mixture of diamine chain extenders in which one of the components, in 20 to 80 mole %, is N-methylethylenediamine, N-ethylethylenediamine or N-isopropyl-1,3-propanediamine or their mixtures. However, while capable of heat-setting at reduced temperatures, the polymer molecular weights in the fiber are expected to drop substantially due to the dissociation reaction of unstable urea groups resulting from the secondary amines from this type of chain extenders, which, in turn, causes the loss of yarn recovery power after the heat treatments.

Published U.S. Patent Application No. 2006/0135724 A1 discloses spandex fibers with improved heat set produced by chain extending an isocyanate-terminated prepolymer with a diamine chain extender that includes: (1) greater than 25 to 75 equivalent percent of an asymmetric aliphatic and/or cycloaliphatic diamine and (2) a linear diamine such as ethylene diamine in the presence of a solvent. The disclosed asymmetric aliphatic and/or cycloaliphatic diamines include: isophorone diamine; 1,2-diaminopropane; methyl-1,3-aminocyclo-hexane; 1,3-diaminocyclohexane; 2-methylpentamethylenediamine; 1,4-diamino-2-methylpiperazine; 1,4-diamino-2,5-dimethylpiperazine; and methyl bis-propylamine. Polyurethaneureas and spandex fibers in this disclosure were specifically made from isocyanate-terminated prepolymers derived from a mixture of a polytetramethylene ether glycol (PTMEG) and an ultra-low unsaturation, high molecular weight polyoxyalkylene diol. These combinations of asymmetric aliphatic and/or cycloaliphatic diamine and linear diamine have limited capabilities in reducing the heat-set temperature or improving the heat settability of the spandex fibers.

WO 2016/085189 A1 discloses polyurethane-urea elastomeric fiber with low-temperature workability, prepared by forming a prepolymer by means of primary polymerization of polyol and diisocyanate, and then a secondary polymerization of the prepolymer, a first chain extender, and a second chain extender, wherein the first chain extender is one or more types selected from among aromatic, aliphatic and alicyclic amines, and the second chain extender is one or more types selected from among aromatic, aliphatic and low molecular-weight diols. This two-step chain extension process is expected to increase production time, equipment cost and process control complications.

U.S. Pat. No. 6,472,494 B2 discloses a spandex fiber with high heat-set efficiency and high unload power, prepared from a polyether glycol, a mixture of 2,4′-methylene diphenyl diisocyanate (MDI) and 4,4′-MDI, and chain extender. However, isomer mixtures with specific distributions of 2,4′-MDI and 4,4′-MDI are either costly or not commercially available, thereby limiting the practicality of this method.

U.S. Pat. No. 7,255,820 B2 discloses a process for the manufacture of an elastic polyurethane fiber with superior heat set properties which requires mixing one component selected from among polystyrene polymers or polystyrene copolymers having a number average molecular weight of 50,000-500,000 with polyurethane having a number average molecular weight of 15,000-100,000. Similarly, CN109610039A discloses a method of using polymeric additives such as polyacrylates and poly(vinyl acetate) or their mixtures for improving the heat-set performances at lower temperatures. While these blend approaches of spandex polymer with thermoplastic polymers gain heat settability, it is at the expense of the stretch/recovery properties as the polystyrene polymers or copolymers and polyacrylates and poly(vinyl acetates) are non-elastomeric and provide no elastic functions.

Therefore, there is a need for methods for production of spandex fibers with low-temperature heat settability which maintain stretch and recovery performance which are simple and effective and use common, commercially available ingredients.

### SUMMARY

An aspect of the present invention relates to a polyurethaneurea composition prepared from an aliphatic and/or alicyclic diamine mixture of chain extenders comprising: (a) a diamine component A with two primary amino groups and a molecular weight less than 120 grams per mole; and (b) a diamine component B with two primary amino groups and a molecular weight of between about 120 and 300 grams per mole.

In one nonlimiting embodiment, diamine components A and B are both aliphatic diamines.

In one nonlimiting embodiment, diamine components A and B are both alicyclic diamines.

In one nonlimiting embodiment, diamine component A is an aliphatic diamine and diamine component B is an alicyclic diamine.

In one nonlimiting embodiment, diamine component A is an alicyclic diamine and diamine component B is an aliphatic diamine.

In one nonlimiting embodiment, the mole percent of diamine component B in the diamine mixture is at least 40%.

In one nonlimiting embodiment, diamine component B comprises two or more substituted alkyl groups along the aliphatic or alicyclic radicals connecting the two primary amino groups of diamine component B.

Nonlimiting examples of aliphatic and alicyclic radicals include alkanes, alkane ethers, cycloalkanes and cycloalkane ether structures and combinations thereof.

In one nonlimiting embodiment, the diamine component B comprises a mixture of isomers with the same molecular weight.

Another aspect of the present disclosure relates to spandex fiber spun from a polyurethaneurea composition prepared from an aliphatic and/or alicyclic diamine mixture of chain extenders comprising: (a) a diamine component A with two primary amino groups and a molecular weight less than 120 grams per mole; and (b) a diamine component B with two primary amino groups and a molecular weight of between about 120 and 300 grams per mole.

In one nonlimiting embodiment, the spandex fiber is dry spun from the polyurethaneurea composition.

In one nonlimiting embodiment, the spandex fiber has a high low-temperature heat set efficiency.

Another aspect of the present disclosure relates to a fabric comprising spandex fiber spun from a polyurethaneurea composition prepared from an aliphatic and/or alicyclic diamine mixture of chain extenders comprising: (a) a diamine component A with two primary amino groups and a molecular weight less than 120 grams per mole; and (b) a diamine component B with two primary amino groups and a molecular weight of between about 120 and 300 grams per mole.

In one nonlimiting embodiment, the fabric further comprises a non-elastomeric fiber.

In one nonlimiting embodiment, the fabric comprising the spandex fiber has a high low-temperature heat set efficiency.

Another aspect of this disclosure relates to an article of manufacture at least a portion of which comprises spandex fiber spun from a polyurethaneurea composition prepared from an aliphatic and/or alicyclic diamine mixture of chain extenders comprising: (a) a diamine component A with two primary amino groups and a molecular weight less than 120 grams per mole; and (b) a diamine component B with two primary amino groups and a molecular weight of between about 120 and 300 grams per mole.

In one nonlimiting embodiment, the article of manufacture is a garment.

In one nonlimiting embodiment, the garment is an active wear or intimate wear garment.

Yet another aspect of the present invention relates to a method for producing spandex fiber comprising reacting a polymeric glycol with a diisocyanate to form an NCO-terminated prepolymer, dissolving the NCO-terminated prepolymer in a suitable solvent and then reacting the solution with an aliphatic and/or alicyclic diamine mixture of chain extenders comprising: (a) a diamine component A with two primary amino groups and a molecular weight less than 120 grams per mole; and (b) a diamine component B with two primary amino groups and a molecular weight of between about 120 and 300 grams per mole to form a polyurethaneurea solution. The solution of polyurethaneurea is then dry-spun to form the spandex.

In one nonlimiting embodiment, the spandex fiber produced via this method has a high low-temperature heat set efficiency.

### DETAILED DESCRIPTION

Fabrics comprising spandex fiber typically require a heat setting process for stabilization. This process exposes the fabric to heat at a predetermined temperature and duration of time while it is in an elongated state. The extent to which the fabric retains this elongated dimension after this heat exposure and any additional fabric processing is completed is known as Heat Set Efficiency.

It is also desirable for the spandex in fabrics so exposed to fuse to itself wherever there are spandex to spandex contact points within the stitch loop matrix. This fusing serves to eliminate a knit fabric's tendency to de-knit or ravel along cut edges or when damaged. This is desirable for the manufacture of garments that may have free-cut, unhemmed edges and for general the durability of the garments.

Provided by this disclosure are segmented polyurethaneurea compositions with unique urea hard segment structures prepared from selected diamine chain extenders and methods for their production. These compositions are useful in dry-spun production of spandex fiber with desired heat settability at lower temperatures, referred to herein as “high low-temperature heat set efficiency”, while maintaining fabric quality with heat-sensitive hard yarns. Fabrics comprising the spandex fibers of this disclosure with high low-temperature heat set efficiency can be heat-set at lower temperatures while still maintaining quality appearance such as flat surface and curl-free edges curls and aesthetics such as hand feel and color luster.

“Spandex”, as used herein, refers to a manufactured filament in which the filament-forming substance is a long chain synthetic polymer comprised of at least 85% by weight of segmented polyurethane. Spandex is prepared by first reacting a polymeric glycol (for example a polyether glycol) with a diisocyanate to form an NCO-terminated prepolymer (a “capped glycol”), dissolving the capped glycol in a suitable solvent such as dimethylacetamide (“DMAc”), dimethylformamide, or N-methylpyrrolidone and then reacting with a difunctional chain extender (and optionally a minor amount of monofunctional chain terminator such as diethylamine, DEA, to limit the polymer molecular weight) to form a polyurethane. The solution of polyurethane is then spun to form the spandex fiber.

Fabrics or yarns which contain spandex in combination with non-elastomeric fibers are typically heat-set to provide the fabric or yarn with good dimensional stability, to shape the finished garment, and for other textile purposes. Typical heat-setting temperatures used in commercial operations are 195° C. for 6,6-nylon, 190° C. for 6-nylon, and 175° C. for cotton. The relatively low temperatures suitable for fibers such as cotton put certain demands on the spandex. For example, if the spandex has an acceptable heat-set efficiency only at temperatures used for the nylons, it cannot be heat-set in a fabric containing cotton, which will be damaged by exposure to such higher temperatures.

Unlike prior methods to lower heat settability involving, for example, addition of thermoplastic polymers which rely upon the melting or softening and freezing of polymeric additives to provide the lower heat settability (See U.S. Pat. No. 7,255,820 B2 and CN109610039A) or reducing the hard segment melting temperature of the segmented polyurethanes by disrupting the crystallization of the urea segments via changing of diisocyanate structures (See U.S. Pat. No. 6,472,494 B2) or the chain extender structures (See U.S. Pat. No. 5,948,875, CN 103255500 B, and US 2006/0135724 A1), it has now been found that a selected mixture of diamines can be used to change the urea hard segment structure without significant impact on other parts of the segmented polyurethane and without drastic alternation of the polymerization process or equipment. The selected mixture of diamines can be used to produce high low-temperature heat set efficiency spandex fiber with heat settability at reduced temperatures and at the same time to balance other physico-mechanical properties such as stretch and recovery performances without complications of the manufacturing process. In addition, the selected diamines as the major component according to the present disclosure have much higher flash point or lower flammability than those commonly used, which is a great benefit for process safety in handling and storing these diamines.

By “high low-temperature heat set efficiency” as used herein, it is meant a spandex or fabric comprising a spandex exhibiting a heat set efficiency at a temperature lower than typically used for spandex processing and safe for other fibers such as, but not limited to, cotton and wool which still results in a spandex fiber with reduced internal stress and low shrinkage upon boil-off in hot water and/or a fabric comprising the spandex that is dimensionally stable at a desired weight per unit area that does not change beyond an acceptable tolerance range, typically less than +/−10%, during consumer use and care, that is smooth in appearance, that exhibits adequate power retention, that will not curl along cut edges to facilitate efficient garment manufacture and allow for garments to be manufactured without hemmed edges, and/or that fuses to itself wherever there are spandex to spandex contact points within the stitch loop matrix serving to eliminate the fabric's tendency to de-knit or ravel along cut edges or when damaged. Thus, in one nonlimiting embodiment, by “high low-temperature heat set efficiency” as used herein, it is meant a heat set efficiency greater than 65%, 70% or 75% at a fabric process temperature less than 190° C. In a preferred embodiment, by “high low-temperature heat set efficiency” as used herein, it is meant a high heat set efficiency of greater than 80%, more preferably 84%-88% at substantially lower temperatures for desired fabric processing such as at 175° C.

As demonstrated herein, aliphatic and/or alicyclic diamines with specific structural features and molecular weight ranges are effective as chain extenders, either by themselves or in combination with a linear short chain diamine such as EDA, to achieve high low-temperature heat set efficiency. More specifically, aliphatic and/or alicyclic diamine mixtures of chain extenders comprising: (a) a diamine component A with two primary amino groups and a molecular weight less than 120 grams per mole; and (b) a diamine component B with two primary amino groups and a molecular weight of between about 120 and 300 grams per mole to form a polyurethane solution results in spandex with the desired characteristics. In one nonlimiting embodiment, diamine component A has a molecular weight between 60 and 120 grams per mole. The mole percent of diamine component B in the diamine mixture is at least 40% and can range anywhere between 40% and 100% of the diamine mixture.

Specific examples of diamines which can be used in the mixtures include, but are not limited to, trimethylhexamethylenediamine (2,2,4- and 2,4,4-mixture) (TMD), poly(propylene glycol) bis(2-aminopropyl ether) (D230) with the molecular weight about 230, isophoronediamine (IPDA), 1,8-diamino-p-menthane, 4,4′-Methylenebis(2-methylcyclohexylamine), 2,2′,6,6′-tetramethyl-4,4′-methylenebis(cyclohexylamine), 2,2-dimethyl-1,5-pentanediamine, 2-butyl-2-ethylpentane-1,5-diamine, 2,2-dipropylpropane-1,3-diamine, 4,4-dimethylheptane-1,7-diamine, 2,2,5,5-tetramethylhexane-1,6-diamine, and 2-[3-(2-aminopropan-2-yl)cyclohexyl]propan-2-amine.

In contrast, experiments performed using a diamine mixture of ethylenediamine (EDA) and hexamethyelenediamine (HMD) as the chain extender or an asymmetric aliphatic diamine, 1,2-propanediamine (PDA), at more than 50 mole % and up to 100 mole % in combination with a linear diamine EDA, failed to consistently achieve the high low-temperature heat set efficiency of fibers of this disclosure. See Comparative Examples.

Thus, provided by this disclosure are polyurethaneurea compositions prepared from an aliphatic and/or alicyclic diamine mixture of chain extenders. The mixture of chain extenders comprises: (a) a diamine component A with two primary amino groups and a molecular weight less than 120 grams per mole; and (b) a diamine component B with two primary amino groups and a molecular weight of between about 120 and 300 grams per mole. In one nonlimiting embodiment, diamine component A has a molecular weight between 60 and 120 grams per mole. The mole percent of diamine component B in the diamine mixture is at least 40% and can range anywhere between 40% and 100% of the diamine mixture.

In one nonlimiting embodiment, diamine components A and B are both aliphatic diamines. In another nonlimiting embodiment, diamine components A and B are both alicyclic diamines. In yet another nonlimiting embodiment, diamine component A is an aliphatic diamine and diamine component B is an alicyclic diamine. In yet another nonlimiting embodiment, diamine component A is an alicyclic diamine and diamine component B is an aliphatic diamine.

In one nonlimiting embodiment, diamine component B comprises two or more substituted alkyl groups along the aliphatic or alicyclic radicals connecting the two primary amino groups of diamine component B. Nonlimiting examples of aliphatic and alicyclic radicals include alkanes, alkane ethers, cycloalkanes and cycloalkane ether structures and combinations thereof.

In one nonlimiting embodiment, the diamine component B comprises a mixture of isomers with the same molecular weight.

This disclosure also provides high low-temperature heat set efficiency spandex fiber spun from the polyurethaneurea compositions disclosed herein and methods for producing the spandex fiber. In addition to the aliphatic and/or alicyclic diamine mixture of chain extenders, spandex fibers of this disclosure further comprise a polymeric glycol (for example a polyether glycol) reacted with a diisocyanate to form an NCO-terminated prepolymer (a “capped glycol”) dissolved in a suitable solvent such as dimethylacetamide (“DMAc”), dimethylformamide, or N-methylpyrrolidone reacted with the diamine mixture of chain extenders. Preferred is that the polymeric glycol and/or diisocyanate be readily available commercially. To produce the spandex fiber, a polymeric glycol is reacted with a diisocyanate to form an NCO-terminated prepolymer. The NCO-terminated prepolymer is then dissolved in a suitable solvent and the resulting solution is reacted with the aliphatic and/or alicyclic diamine mixture of chain extenders comprising: (a) a diamine component A with two primary amino groups and a molecular weight less than 120 grams per mole; and (b) a diamine component B with two primary amino groups and a molecular weight of between about 120 and 300 grams per mole to form a polyurethane solution. The solution of polyurethaneurea is then dry-spun to form the spandex.

In one nonlimiting embodiment, the high low-temperature heat set efficiency spandex fiber produced via this method has a heat set efficiency greater than 65%, 70% or 75% at a fabric process temperature less than 190° C.

In one nonlimiting embodiment, the high low-temperature heat set efficiency spandex fiber produced via this method has a heat set efficiency of at least 80% at 175° C.

In one nonlimiting embodiment, the high low-temperature heat set efficiency spandex fiber produced via this method has a heat set efficiency of about 84% to about 88% at 175° C.

Nonlimiting examples of conventional additives, which may also be included in the high low-temperature heat set efficiency spandex fiber to improve polymer properties, include antistatics, antioxidants, antimicrobials, flameproofing agents, lubricants, dyestuffs, light stabilizers, polymerization catalysts and auxiliaries, adhesion promoters, delustrants, such as titanium oxide, matting agents, and/or organic phosphites.

In one nonlimiting embodiment the spandex fiber is dry spun from the polyurethaneurea composition.

As demonstrated herein, incorporation of spandex fiber spun from the polyurethane compositions disclosed herein into fabric results in fabric which can be heat-set at lower temperatures while still maintaining quality appearance such as flat surface and curl-free edges curls and aesthetics such as hand feel and color luster.

Thus, the present disclosure also provides fabric comprising the high low-temperature heat set efficiency spandex fiber spun from the polyurethaneurea compositions. In some nonlimiting embodiments, the fabric further comprises one or more non-spandex fibers. Nonlimiting examples of non-spandex fibers useful in fabrics of this disclosure include cotton, nylon, polyester, acrylic, and wool.

In one nonlimiting embodiment, the fabric of this disclosure has a heat set efficiency greater than 65%, 70% or 75% at a fabric process temperature less than 190° C. In one nonlimiting embodiment, fabric produced from the spandex fiber disclosed herein has a heat set efficiency of at least 80% at a fabric process temperature of 175° C. More preferably, the fabric has a heat set efficiency of about 84% to about 88% at a fabric process temperature of 175° C.

To control polyurethaneurea molecular weight, at least one monofunctional chain terminator can be used, for example diethylamine, di-n-butylamine, n-pentylamine, n-hexylamine, cyclohexylamine, n-heptylamine, methylcyclohexylamines (for example 1-amino-3-methylcylohexane, 1-amino-2-methylcyclohexane, and 1-amino-3,3,5-trimethylcyclohexane), n-dodecylamine, 2-aminonorbornane, 1-adamantanamine, ethanolamine, methanol, ethanol, n-butanol, n-hexanol, n-octanol, n-decanol, and mixtures thereof. Terminators such as cyclohexylamine and diethylamine are preferred.

This disclosure also relates to article of manufacture at least a portion of which comprises the high low-temperature heat set efficiency spandex fiber spun from the polyurethaneurea compositions or fabric thereof as disclosed herein.

In one nonlimiting embodiment, the article of manufacture is a garment or apparel.

Examples of apparel or garments that can be produced using the compositions, fiber and/or fabric disclosed herein, include but are not limited to: undergarments, brassieres, panties, lingerie, swimwear, shapers, camisoles, hosiery, sleepwear, aprons, wetsuits, ties, scrubs, space suits, uniforms, hats, garters, sweatbands, belts, activewear, outerwear, rainwear, cold-weather jackets, pants, shirtings, dresses, blouses, men's and women's tops, sweaters, corsets, vests, knickers, socks, knee highs, dresses, blouses, aprons, tuxedos, bisht, abaya, hijab, jilbab, thoub, burka, cape, costumes, diving suit, kilt, kimono, jerseys, gowns, protective clothing, sari, sarong, skirts, spats, stola, suits, straitjacket, toga, tights, towel, uniform, veils, wetsuit, medical compression garments, bandages, suit interlinings, waistbands, trims and all components therein.

The following test methods were used to characterize fiber and fabrics of this disclosure.

### Test Methods

The stretch and recovery properties of the spandex fibers were measured in accordance with the general method of ASTM D 2731-72. Three filaments, a 2-inch (5 centimeters) gauge length and a 0-300% elongation cycle were used for each of the measurements. The samples were cycled five times at a constant elongation rate of 50 centimeters per minute. Load power (TP2), the stress on the spandex fiber during initial extension was measured on the first cycle at 200% extension and is reported as centiNewtons. Unload power (TM2) is the stress at an extension of 200% for the fifth recovery cycle after the applied tension is released, and is also reported as centiNewtons. Percent elongation at break (ELO) in percent and yarn break tenacity (TEN) in centiNewtons were measured on a sixth extension cycle.

The spandex fiber heat-set efficiency (HSE) was measured by mounting the fiber thread of 10 centimeter original length (OL) on a heat-set frame straight free of tension, stretched and fixed to 1.5× or 15 centimeters stretched length (SL), placed horizontally in the heat-set oven for 120 seconds at 175° C., followed by relaxed boil-off on the frame for 30 minutes, dried the thread lines by air in a fume hood for 60 minutes before measuring the relaxed length (RL) for calculating the heat-set efficiency by the equation below:

$$H S E ( \% ) = ( R L - O L ) \times 100 / ( S L - O L )$$

The features and advantages of the spandex of this disclosure invention are more fully shown by the following examples which are provided for purposes of illustration, and are not to be construed as limiting the invention in any way.

### EXAMPLES

### Example 1: Spandex Fiber

Extensive testing was performed with polyurethaneureas in N,N-dimethylacetamide (DMAc) solution batches of different compositions varying in the % NCO of the prepolymer or the capped glycol and the chain extender types and mix ratios. In general, the preparation of the polymer follows the same procedures as described in the following:

Poly(tetramethylene ether) glycol (PTMEG) with a number average molecular weight of 1800 (T1800) was mixed with excess methylene bis(4-phenyl isocyanate) (MDI), in an amount to achieve the targeted % NCO of the prepolymer, in a glass reaction kettle in a glove box under dry nitrogen atmosphere. The mixture was heated under agitation to a temperature of 85 to 90° C. for 90 minutes to complete the reaction in forming the viscous prepolymer with terminal isocyanate groups. Meanwhile, a chain extender solution was prepared with a mixture of selected diamines at pre-determined molar ratios in DMAc, and the concentration the extender solution was controlled to 2.00 milliequivalent amino (NH₂) group per gram of solution. Similarly, a chain terminator solution of diethylamine or (DEA) in DMAc was prepared with the concentration of 1.00 milliequivalent of DEA per gram of the solution. The capped glycol prepolymer was then dissolved in DMAc by high speed agitations, and the amount of DMAc was controlled in a way to have the polymer solids at 34.0% by weight percent. After the prepolymer was completely dissolved in DMAc, the pre-weighed amount of the chain extender solution and the terminator solution were mixed together and added quickly to the diluted prepolymer solution in DMAc for chain extension reaction under continuous agitations. The amount of the chain extender solution was used to keep the primary amino (NH2) groups at 15 milliequivalent per kilogram of the polymer solid after the chain extension, while the terminator solution amount was adjusted to keep the polymer solution viscosity in a range of 2500 to 4500 poises measured at 40° C. by a Brookfield Viscometer equipped with a small sample adaptor. Amounts by weight percent of the ingredients used for making the polymer solutions, including T1800 glycol, MDI, extender mixture, and terminator, are shown in the following tables for the examples and comparative examples.

The as-made polymers had a number average molecular weight (Mn) in a range of 25,000 to 32,000 and a weight average molecular weight (Mw) in a range of 90,000 to 130,000, as measured by gel permeation chromatography (GPC).

The as-made polymer solutions comprising components with wt % ranges as follows: polymeric glycol (67-80 wt %), MDI (18-23 wt %), EDA (0-1.6 wt %), secondary diamine selected from PDA, HMD, D230, TMD or IPDA (0.8-9 wt %) and DEA 0.07-0.36 wt %) were mixed as a slurry with typical additives including antioxidant and processing reagents. The mixed polymer solutions were then spun into spandex fibers of dtex consisting of 4 filaments by a conventional drying spinning process with a winding speed of 853 meters per minute. The as-spun yarns were used for measurements of tensile properties and heat set efficiency as described in the test method section. Results are shown in the following tables.

Results for Comparative Fiber Example 1 with EDA/PDA Diamine Mixture

| Polymer Parts | 2201X | 2201A | 2201E | 2201F | 2201G | 2201H | 2201I | 2201J |
|---|---|---|---|---|---|---|---|---|
| Chain | EDA/PDA | EDA/PDA | EDA/PDA | EDA/PDA | EDA/PDA | EDA/PDA | EDA/PDA | EDA/PDA |
| extender | | | | | | | | |
| Extender | 30/70 | 0/100 | 10/90 | 20/80 | 30/70 | 40/60 | 50/50 | 55/45 |
| molar ratio | | | | | | | | |
| Prepolymer | 3.80 | 3.80 | 3.60 | 3.40 | 3.20 | 3.00 | 2.80 | 2.40 |
| % NCO Target | | | | | | | | |
| 44 dtex Yarn | | | | | | | | |
| Properties | | | | | | | | |
| HSE at | 53.46 | 58.53 | 56.33 | 55.73 | 53.00 | 51.73 | 49.73 | 50.13 |
| 175° C., % | | | | | | | | |
| Load power | 10.39 | 8.26 | 9.75 | 9.56 | 8.54 | 7.68 | 8.60 | 6.84 |
| (TP2), cN | | | | | | | | |
| Unload power | 1.20 | 1.12 | 1.26 | 1.25 | 1.23 | 1.24 | 1.22 | 1.16 |
| (TM2), cN | | | | | | | | |
| Elogation | 358 | 384 | 397 | 393 | 371 | 371 | 433 | 436 |
| at break | | | | | | | | |
| (ELO), % | | | | | | | | |
| Tenacity | 42.8 | 43.6 | 50.4 | 51.8 | 35.3 | 41.4 | 56.9 | 54.3 |
| at break | | | | | | | | |
| (TEN), cN | | | | | | | | |

Results for Comparative Fiber Example 2 with EDA/PDA Diamine Mixture

| Polymer Parts | 2202A | 2202B | 2202C | 2202D | 2202I |
|---|---|---|---|---|---|
| Chain extender | EDA/HMD | EDA/HMD | EDA/HMD | EDA/HMD | EDA/HMD |
| Extender molar ratio | 50/50 | 70/30 | 30/70 | 10/90 | 50/50 |
| Prepolymer % NCO | 3.40 | 3.00 | 3.00 | 3.00 | 3.00 |
| Target | | | | | |
| 44 dtex Yarn Properties | | | | | |
| HSE at 175° C., % | 73.03 | 62.90 | 81.70 | 74.90 | 79.73 |
| Load power (TP2), cN | 8.53 | 7.47 | 7.40 | 7.65 | 7.17 |
| Unload power (TM2), cN | 1.18 | 1.15 | 1.16 | 1.13 | 1.09 |
| Elogation at break | 424 | 445 | 434 | 409 | 425 |
| (ELO), % | | | | | |
| Tenacity at break (TEN), | 51.2 | 47.3 | 43.6 | 42.3 | 51.1 |
| cN | | | | | |

Results for Fiber Example 1 with EDA/D230 Diamine Mixture

| Polymer Parts | 2203X | 2203A | 2203B | 2203C | 2203D | 2203E3/4 | 2203F3/4 |
|---|---|---|---|---|---|---|---|
| Chain | EDA/D230 | EDA/D230 | EDA/D230 | EDA/D230 | EDA/D230 | EDA/D230 | EDA/D230 |
| extender | | | | | | | |
| Extender | 30/70 | 85/15 | 70/30 | 50/50 | 10/90 | 45/55 | 40/60 |
| molar ratio | | | | | | | |
| Prepolymer | 3.80 | 2.80 | 3.20 | 3.60 | 4.00 | 3.80 | 3.80 |
| % NCO Target | | | | | | | |
| 44 dtex Yarn | | | | | | | |
| Properties | | | | | | | |
| HSE at | 102.7 | 64.67 | 75.73 | 85.13 | broke | 82.73 | 86.07 |
| 175° C., % | | | | | | | |
| Load power | 3.08 | 5.86 | 7.04 | 6.31 | 1.06 | 5.56 | 4.34 |
| (TP2), cN | | | | | | | |
| Unload power | 0.74 | 0.99 | 0.65 | 1.03 | 0.35 | 0.61 | 0.58 |
| (TM2), cN | | | | | | | |
| Elogation | 522 | 523 | 445 | 425 | 791 | 400 | 399 |
| at break | | | | | | | |
| (ELO), % | | | | | | | |
| Tenacity | 46.0 | 37.1 | 36.9 | 41.9 | 27.8 | 28.0 | 18.8 |
| at break | | | | | | | |
| (TEN), cN | | | | | | | |

Results for Fiber Example 2 with EDA/TMD Diamine Mixture

| Polymer Parts | 2204X | 2204A | 2204B | 2204C | 2204D |
|---|---|---|---|---|---|
| Chain extender | EDA/TMD | EDA/TMD | EDA/TMD | EDA/TMD | EDA/TMD |
| Extender molar ratio | 30/70 | 85/15 | 70/30 | 50/50 | 10/90 |
| Prepolymer % NCO Target | 3.80 | 2.80 | 3.20 | 3.60 | 4.00 |
| 44 dtex Yarn Properties | | | | | |
| HSE at 175° C., % | 85.93 | 56.93 | 58.20 | 71.93 | broke |
| Load power (TP2), cN | 5.12 | 6.55 | 7.23 | 5.87 | 2.00 |
| Unload power (TM2), cN | 0.93 | 1.10 | 1.14 | 1.12 | 0.65 |
| Elogation at break (ELO), % | 434 | 489 | 436 | 427 | 598 |
| Tenacity at break (TEN), cN | 37.5 | 39.1 | 45.6 | 44.0 | 25.3 |

Results for Fiber Example 3 with EDA/IPDA Diamine Mixture

| Polymer Parts | 2205X | 2205A | 2205B | 2205C | 2205D | 2205F |
|---|---|---|---|---|---|---|
| Chain extender | EDA/IPDA | EDA/IPDA | EDA/IPDA | EDA/IPDA | EDA/IPDA | EDA/IPDA |
| Extender molar ratio | 30/70 | 50/50 | 40/60 | 20/80 | 10/90 | 0/100 |
| Prepolymer % NCO | 3.80 | 3.60 | 3.70 | 3.90 | 4.00 | 5.00 |
| Target | | | | | | |
| 44 dtex Yarn | | | | | | |
| Properties | | | | | | |
| HSE at 175° C., % | 77.85 | 66.80 | 72.40 | 84.09 | broke | 69.70 |
| Load power (TP2), cN | 6.91 | 7.38 | 5.08 | 3.81 | 3.64 | 6.75 |
| Unload power (TM2), | 0.93 | 1.13 | 1.00 | 0.73 | 0.63 | 0.84 |
| cN | | | | | | |
| Elogation at break | 386 | 408 | 421 | 505 | 475 | 412 |
| (ELO), % | | | | | | |
| Tenacity at break | 37.1 | 41.2 | 32.6 | 38.9 | 26.5 | 30.5 |
| (TEN), cN | | | | | | |

### Example 2: Fabric

Spandex test fibers were knit into a fabric using a 44 gauge, Monarch circular knitting machine in single jersey construction. Each test fabric was comprised of a spandex fiber of 44 dtex and a fully drawn nylon 6,6 fiber of 44 dtex and 34 filaments. The spandex and nylon fibers were plaited together and knit on every course.

The resulting knitted greige fabric was scoured in a Theis model DF 33 Horizontal Jet Dye machine in an aqueous bath with a surfactant for 20 minutes at 70° C., excess water removed in a centrifugal extractor and air dried on a rack for 24 hours at ambient temperature. The width of the fabrics at the end of this stage was recorded as Scoured Width (SW).

Fabrics were then heat set on a conventional pin-type tenter frame at 149.2 cm, with overfeed tension settings targeting 130 knit courses per inch, for 45 seconds at 175° C. The width of the fabrics at the end of this stage was recorded as Heat Set Width (HSW).

Fabrics were then dyed in a Theis model DF 33 Horizontal Jet Dye machine using a typical aqueous acid dye procedure for nylon fabrics at 98° C. for 30 minutes, followed by an exhaust application of a silicone-based fabric softener at 2% of the weight of the fabric. Fabrics were removed from the dye machine, excess water removed in a centrifugal extractor and air dried on a rack for 24 hours at ambient temperature. The width of the fabrics at the end of this stage was recorded as Finished Width (FW).

The Heat Set Efficiency (HSE) of the fabrics was calculated with the formula:

HSE=(FW−SW)/(149.2−SW)*100%

Fabrics were also physically examined for spandex fusion to itself by mounting a section of the fabric in a sewing hoop, pulling and cutting a stitch loop from the body of the fabric and examining the exposed spandex under a microscope.

Fabrics comprising a nylon yarn and a spandex yarn as described above were made as follows:

### Fabric Identification Description

Fabric made using a control spandex of an existing commercial fiber composition with low thermal setting temperature
44-TB Fabric made using a test spandex with 75% IPDA co-extender
44-TH Fabric made using a test spandex with 65% IPDA co-extender
44-TN Fabric made using a test spandex with 50% IPDA co-extender

| FABRIC | SW, cm | HSW, cm | FW, cm | HSE |
|---|---|---|---|---|
| 44-CC | 116.1 | 143.5 | 144.0 | 84.3% |
| 44-TB | 113.5 | 143.5 | 143.0 | 82.6% |
| 44-TH | 116.7 | 142.2 | 140.0 | 71.7% |
| 44-TN | 116.4 | 139.7 | 135.5 | 58.2% |

The control fiber used in the fabric 44-CC, is known to have a commercially acceptable HSE when heat set at 175′° C. Fabrics 44-TB and 44-TC have a similar HSE to 44-CC at this temperature indicating that their HSE performance would also be commercially acceptable.

Fabrics 44-CC, 44-TB and 44-TH had strong spandex to spandex fusion at 175° C. heat setting.

Item 44-TN had moderate spandex to spandex fusion at 175° C. heat setting.

What is claimed is:

1. A polyurethaneurea composition comprising:
a polymeric glycol;
a diisocyanate;
solvent; and
an aliphatic and/or alicyclic diamine mixture of chain extenders comprising:
(a) a diamine component A with two primary amino groups and a molecular weight less than 120 grams per mole; and
(b) a diamine component B with two primary amino groups and a molecular weight of between about 120 and 300 grams per mole.

2. The polyurethaneurea composition of claim 1 wherein the diamine components A and B are both aliphatic diamines.

3. The polyurethaneurea composition of claim 1 wherein diamine components A and B are both alicyclic diamines.

4. The polyurethaneurea composition of claim 1 wherein diamine component A is an aliphatic diamine and diamine component B is an alicyclic diamine.

5. The polyurethaneurea composition of claim 1 wherein diamine component A is an alicyclic diamine and diamine component B is an aliphatic diamine.

6. The polyurethaneurea composition of claim 1 wherein the mole percent of diamine component B in the diamine mixture is at least 40%.

7. The polyurethaneurea composition of claim 1 wherein diamine component B comprises two or more substituted alkyl groups along the aliphatic or alicyclic radicals connecting the two primary amino groups of diamine component B.

8. Spandex fiber spun from the polyurethaneurea composition of any of claims 1 through 7.

9. The spandex fiber of claim 8 which is dry spun from the polyurethaneurea composition.

10. The spandex fiber of claim 8 which has a high low-temperature heat set efficiency.

11. A fabric comprising the spandex fiber of any of claims 8 through 10.

12. The fabric of claim 11 further comprising a non-elastomeric fiber.

13. The fabric of claim 11 which has a high low-temperature heat set efficiency.

14. An article of manufacture at least a portion of which comprises spandex of any of claims 8 through 10 or fabric of claims 11 through 13.

15. A method for producing spandex comprising:
reacting a polymeric glycol with a diisocyanate to form an NCO-terminated prepolymer;
dissolving the prepolymer in a suitable solvent; and
reacting the solution with an aliphatic and/or alicyclic diamine mixture of chain extenders comprising:
(a) a diamine component A with two primary amino groups and a molecular weight less than 120 grams per mole; and
(b) a diamine component B with two primary amino groups and a molecular weight of between about 120 and 300 grams per mole to form a polyurethane solution.

16. The method of claim 15 wherein the diamine components A and B are both aliphatic diamines.

17. The method of claim 15 wherein diamine components A and B are both alicyclic diamines.

18. The method of claim 15 wherein diamine component A is an aliphatic diamine and diamine component B is an alicyclic diamine.

19. The method of claim 15 wherein diamine component A is an alicyclic diamine and diamine component B is an aliphatic diamine.

20. The method of claim 15 wherein the mole percent of diamine component B in the diamine mixture is at least 40%.

21. The method of claim 15 wherein diamine component B comprises two or more substituted alkyl groups along the aliphatic or alicyclic radicals connecting the two primary amino groups of diamine component B.

22. The method of any of claims 15 through 21 wherein the spandex has a high low-temperature heat set efficiency.
